(19) United States
(12) Patent Application Publication
(10) Pub. No.: US 2001/0047342 A1
(43) Pub. Date: Nov. 29, 2001

(54) Credit or debit cards of all kinds to be issued with a bank savings account attched

(76) Inventor: Vincent Cuervo, Coral Gables, FL (US)

Correspondence Address: Vincent Cuervo, 1545 Miller Road, Coral Gables, FL, 33146-2309, US

(21) Appl. No.: 09/894,581

(22) Filed: Jun. 28, 2001

Related U.S. Application Data
(63) Continuation-in-part of application No. 09/524,496, filed on Mar. 13, 2000.
Application No. 09/524,496 is a continuation-in-part of application No. 09/128,088, filed on Aug. 3, 1998, now Pat. No. 6,105,009.
Application No. 09/128,088 is a continuation-in-part of application No. 08/877,006, filed on Jun. 16, 1997, now abandoned.

(51) Int. Cl. G06F 17/60; H04L 9/00

(52) U.S. Cl. 705/66; 705/67; 705/17

(57) ABSTRACT

This Method and System Invention relates to credit or debit cards of all kinds issued by a bank(s) or financial institution which when issued convey an interest earning savings account opened by the same bank issuing the card.

The card may be a Credit or Debit card of any kind, including but not limited to: an Affinity Credit Card; a Gift Card; a Prepaid Debit Card; a Stored Value Card; a Corporate Credit or Debit Card; a Bank Card; a Funded Card, et al.

This invention will provide the user a Method and System the benefits of an attached savings account which will, by electronic (EFT) transfers, receive the funds developed by discounts, rebates or rebates offered by participating stores and or service provider entities when purchasing their merchandise or services using the card.

Users of this Method and System will benefit from discounts, rewards or rebates to which they may not be entitled when using presently credit or debit cards available.

The deposited funds, product of discounts, rebates, rewards or additional deposits made by the cardholder to the Savings Account, may be transferred by the cardholder to increase its debit card stored amount or to reduce an owed balance in a credit card. Withdrawal of funds in full when the card is cancelled.

A previous bank relationship is unnecessary and not requested to obtain this prepaid or stored value debit card, for credit cards and bank check debit cards may be required a previous bank relationship of an existing or new checking account.

### BACKGROUND OF THE INVENTION

1. Field of the Invention

This Method and System Invention relates to credit or debit cards of any kind issued by bank(s) or financial institution which when issued convey an interest earning savings account opened by the same bank who issued the card.

The card may be a Credit or Debit card of any kind, including but not limited to: an Affinity Credit Card; a Gifi Card; a Prepaid Debit Card; a Stored Value Card; a Corporate Credit or Debit Card; a Bank Card; a Funded Card, et al.

2. The present application is a continuation-in-part of pending U.S. patent application Ser. No. 09/524,496 filed Mar. 13, 2000, which in turn is a continuation-in-part of U.S. Pat. No. 6,105,009 issued on Aug. 15, 2000, which in turn is a continuation-in-part of abandoned application Ser. No. 08/877,006 filed on Jun. 16, 1997, which are incorporated by reference.

3. Description of the Related Art

The applicant believes that there are not issued patents or patent applications pending describing a subject matter close to the novel features of the present invention.

### SUMMARY OF THE INVENTION

It is one of the main objects of the present invention to provide a Method and System applicable to all the Credit or Debit Cards, Prepaid, Stored Value, Gift, ATM, Affinity, Check, Corporate, Bank Check Cards or any card(s) in the market.

It is another object of this invention to provide the user of a Method and System that will guarantee the card users benefits from receiving valuable percentage of discounts, rebates or rewards when purchasing merchandise or paying for services.

It is yet another object of the present invention to allow the users to earn and deposit those earned funds from discounts, rebates or rewards in an earning interest Savings Account opened, free of charges, by the issuing Bank at the time or after the card is issued.

It is still another object of this invention to facilitate users of this Method and System the benefit of discounts, rewards or rebates to which may not benefit now when using presently available cards.

It is also another object of this invention to procure a card easy to be replenished and in case of lost or stolen replaceable.

Further objects of the invention will be brought out in the following part of the specifications, wherein detailed description is for the purpose of fully disclosing the invention without placing limitations thereon.

### BRIEF DESCRIPTION OF THE DRAWINGS

With the above and other related objects in view, the invention Consist in the details of combining electronic transactions which will be more fully understood from the following description, when read in conjunction with the accompanying drawings in which:

FIG. 1 represents a block of the system hardware used in one of the preferred embodiments for the present invention, and steps requiring the validation and activation after dispensing the credit or debit card and opening of the savings account by the issuing bank.

### DETAILED DESCRIPTION OF THE PREFERRED EMBODIMENT

Referring now to the drawings, where the present invention is generally referred to with numeral it can be observed that it basically includes a card system enabling costumers the access to Point of Sales Terminal (POS) or “Smart” Card-Reading Terminals 54 credit and debit cards data controlling bank cards that includes basically a keypad with numbers, letters, names, graphics and signs, with a sliding open side, all integrating a point of sale terminal 54 accessible to magnetic memory stripe variety or the “smart” cards-wallet-size electronic payment cards with embedded microchips card-reading terminals which tracking electronic transactions electronically through its microchips. 40 seller-dispenser merchants or license entities who has agreed to grant discounts or rebates on purchase of merchandise or for service provided when using the card, and to the electronically transfer the funds to purchaser's 30 Savings Account opened and attached to the card. The seller may be 40 a store's employee acting as dispenser or the 48 Bank issuing the cards who opened the Savings Account acting in a dual function, or authorized entities. Clearing house 56 and network system 60 with it's various functional components: a plurality of credit and debit cards, a host computer, on site activating terminals and processor. Issuing Bank 48 receiving input from Clearing House 56 generating activation and authorization signals 62 to 48 who is proceeding the process of issuing of the card and the opening the Savings Account and card delivery 64. For the purpose of this application, a purchaser 30 will be deemed the “purchaser”, the “user” or the “cardholder”. Authorized seller-dispenser 40 may be a merchant's employee at a store, service provider entities or bank 48 selling the card to purchaser. The seller-dispenser 40 will maintain supply of cards available in or out vault with a digital storage number 46 wherein a unique identifying serial number has been recorded, and identified by 48. Plurality of an on-site activation Point-of-Sale terminals 54 with the needed input and output hardware of card charges, card debits and card credits 58, computer assembly 60 and associated storage assembly 50.

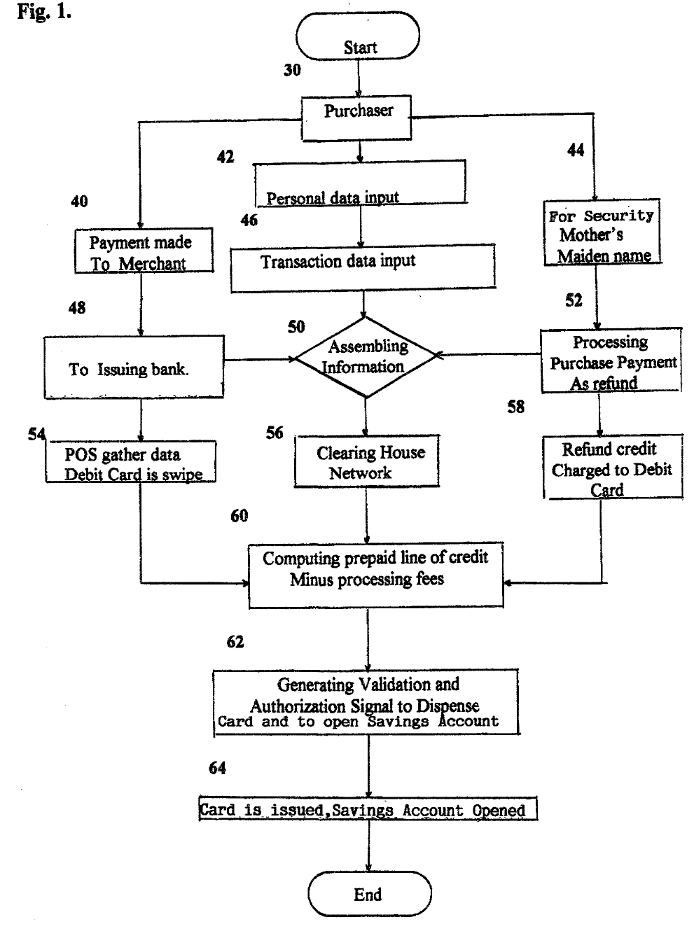

As shown in FIG. 1, a card purchaser 30 initiates the process when approaching a participating 40 merchant or entity, the seller-dispenser enters the sale of the card for activation through the POS 54 after completing purchase or acquiring the card, the purchaser 30 receives the card, with or without confidential four digit numbers or letters combined (PIN) as instructed by issuer, supplying to 48 other required other information as 30 mother's maiden name 44 for security purposes only (lost card to be replace, for reloading, for adding money in savings account, to make withdraws, etc . . . ). The 48 issuer will determine the information it will require, or can make it optional, leaving latitude and flexibility for whatever the purchaser 30 want to disclose.

The steps ahead pertain to inputs regarding amount to be stored in the card, method of payment (cash, check, with another card), and if obtaining a credit card, the amount of the line of credit and the customary requirements. Seller 40 enters payment crediting the issuing Bank 48 for computing net prepaid amount enter 60 signaling 62 validation, activation and authorization from 56 clearing house to the Savings Account for dispensing or delivering the card to purchaser 30 with a prepaid value or line of credit within equal to the payment received minus a small processing fee, issuing the card and opening the bank Savings Account 64. A net prepaid amount is credited, and the debit card is swipe into 54 (POS), as a credit charge equal to the net amount prepaid.

When more of one card is dispensed to the same purchaser, the serial numbers will be linked to each other with the software will then look and function as if were only one same number. In this manner, a card purchaser may give one or more cards to others (child in college, traveling salesman, relatives in foreign countries, etc.) who will be able to use the card within the available prepaid amount. The card purchaser can then reload the card for other's remote usage, thus effectively constituting an instant finds transfer.

The data of the user and the transaction, as well as the serial number(s) being entered, will be assembled in the predetermined manner and forwarded through clearing house 56 network 60, and through the existing facilities provided by the Point-of-Sale terminals.

The foregoing description conveys the best understanding of the objectives and advantages of the present invention. Different embodiments may be made of the inventive concept of this invention. It is to be understood that all matter disclosed herein is to be interpreted merely as illustrative, and not in a limited sense.

What is claimed is:

1. A method and system for the sale, dispensing or delivering validating and activating credit and debit cards, the magnetic-only variety cards and or the “Smart” cards-wallet-size electronic payment cards with embedded microchips, with an attached or associated new Savings Account opened by the issuing Bank, comprising:
(A) A plurality of on site point of sale terminal or “Smart” cards readers located at participating merchant store and service providers, authorized entity or an issuing bank, including first computer means with associated first storage means that further includes input and output means for entering data from merchant, and from purchaser pertaining to him or her, the issuing Bank and the particulars of the transaction in said first storage means, said first input means includes a keypad assembly and further including means for funds validation and the use of the card through said input means so that a line of credit is computed by first computer means and storage in said first storage means with a validation signal and a block of data is assembled including the new savings account opening and readiness for transmission;
(B) Means for dispensing or delivering an issue a credit or debit card for each transaction, and each of said cards including means for storing a unique identification number(s) and said cards being dispensed and or delivered and validated only after a first predetermined number of conditions have been met and said validation signal is received from the issuer.
(C) A remotely located computerized clearing house assembly, including second computer means, second input and output means for receiving and sending said block of information so that a line of credit prepaid to the issuer or pre-approved by the issuer is entered for each said identification number(s).

2. The point-of-sale terminal set forth in claim 1, wherein the instructions and data in said second means permit an issuer to offer user to link more than one said identification numbers of said card to one line of credit thereby permitting more than one user to simultaneously to access said credit line, when using the magnetic black stripe variety card or the “smart” cards-wallet-size electronic payment cards with embedded microchips at new card readers point of sale new terminals.

3. The point-of-sale terminal set forth in claim 2 wherein the instructions and data in said second means permit an issuer to affect the line of credit of the users upon occurrence of a second predetermined conditions.

4. The point-of-sale terminal set forth in claim 3 wherein said second predetermined conditions including processing and opening of an attached or associated new interest earning bank savings account by the card issuing Bank for deposit of earning derived from the merchant or service provider's discounts, rebates or rewards made to purchaser when using the card in payment for purchased merchandise or acquired services.

5. The point-of-sale terminal set forth in claim 3 wherein said second predetermined conditions includes the passage of time with unused balances.

6. The point-of-sale terminal set forth in claim 3 wherein said second predetermined conditions includes the use of said cards in predetermined geographic locations.

7. The point-of-sale terminal set forth in claim 6 wherein said line of credit, prepaid or pre-approved, is calculated by issuer in one or more pre-selected foreign currencies.

8. The point-of-sale terminal set forth in claim 7 wherein other predetermined incentives are added to said line of credit and or card, selectively, upon occurrence of said second number of predetermined conditions.

9. The point-of-sale terminal set forth in claim 8 wherein other predetermined transactions that will allow users to increase the funds in the card or reduce them, either by depositing additional funds or by transferring funds for increasing the line of credit at a debit card or if a credit card may be transferred to reduce the owed balance in the card, this transfer may be available if leaving a small balance in the savings account to preserve the it. The full withdrawal can be done at card account is canceling.

10. The point-of-sale terminal set forth in claim 9 wherein other predetermined transactions that will transfer (EFT) to user's opened savings account, at the issuing bank, earned funds (excluded taxes, or tips) by user on discounts, rebates or rewards received from purchasing merchandise or service provided by participating stores or entities crediting the card when purchasing using it.

11. Purchasing, valuating, activating and the issue of the card when it is a prepaid or store value debit card do not required a previous bank relationship with a checking account opened and will not be requested to be open. Other debit and credit cards may require previous bank relationship or the opening of a checking account.
